(19) United States
(12) Patent Application Publication
(10) Pub. No.: US 2015/0087462 A1
(43) Pub. Date: Mar. 26, 2015

(54) WOBBLE BODY GEAR

(71) Applicant: Iwis motorsysteme GmbH & Co. KG, Munchen (DE)

(72) Inventors: Reinhard MULLER, Landsberg (DE); Michael FRANK, Otterfing (DE); Alexander SALZSEILER, Munchen (DE)

(21) Appl. No.: 14/493,233

(22) Filed: Sep. 22, 2014

(30) Foreign Application Priority Data
Sep. 24, 2013 (DE) 102013015843.5

(51) Int. Cl. F16H 1/32; F02D 13/02

(52) U.S. Cl. CPC F16H 1/32; F02D 13/0219
USPC 475/162

(57) ABSTRACT

A gear mechanism with a sun gear and a ring gear is provided, where the sun gear and the ring gear are arranged coaxial relative to a gear axis of rotation, and with a transmitter element and an actuating device. The transmitter element comprises a revolving transmitter ring which is arranged eccentric relative to the gear axis of rotation and in sections engages with the sun gear and the ring gear. The actuating device comprises a wobble body, where the revolving transmitter ring is movable by the wobble body eccentrically about the gear axis of rotation in order to move the sun gear and the ring gear relative to each other. A cam phaser for an internal combustion engine having such a gear mechanism is also provided.

### CROSS-REFERENCE TO RELATED APPLICATION

This application claims priority to foreign German patent application No. DE 102013015843.5, filed on Sep. 24, 2013, the disclosure of which is incorporated by reference in its entirety.

### FIELD OF THE INVENTION

The present invention relates to a gear mechanism with a sun gear and a ring gear, where the sun gear and the ring gear are arranged coaxial to a gear axis of rotation, and with a transmitter element and an actuating device. The invention further relates to a respective cam phaser for an internal combustion engine.

### BACKGROUND

Conventional planetary gear mechanisms are used in the art as single or multi-stage gear units for very different applications. In this, the planetary gear mechanisms can be designed as a toothed gear mechanism or a friction gear mechanism and can, in addition to axes fixed to the frame not changing their position in the gear housing, also comprise revolving axes revolving in circular orbits in the gear mechanism. In addition to the transmission of a rotational motion, addition and distribution gears are with a planetary gear mechanism easily realized. Since planetary gear mechanisms always have at least two shafts fixed to the frame and one revolving shaft, at least one two-stage gear transmission is always given with a relatively high transmission ratio in contrast to simple single-stage stationary gear mechanisms. When arranging an outer ring gear and an inner sun gear in one plane, a particularly slim planetary gear mechanism can be realized.

The possibility of a planetary gear mechanism in a three-shaft operation using two shafts for driving the gear mechanism and always using one shaft for the output side enables a large range of different applications, for example, for driving hybrid vehicles Transmission devices adjustable in the angle of rotation that are used as cam phasers for increasing performance and fuel economy in modern internal combustion engines are usually designed as single-stage or multi-stage planetary gear mechanisms.

Cam phasers allow for adjustment of valve opening times to the load behavior of the engine during operation of internal combustion engines. The adjustment of overlap times of the exhaust valves and intake valves allows not only for fuel savings as well as power and torque gains but also for reduction in emissions, which is important in view of the ever-increasing requirement to comply with emission standards.

In addition to planetary gear mechanisms, a whole number of different designs and concepts for transmission devices that are adjustable in the angle of rotation are used as cam phasers. Most widely spread are nowadays hydraulic cam phasers that are based on a swing motor known from hydraulic technology and equipped with several vanes to increase the transmittable torque. Hydraulic cam phasers are in the internal combustion engine driven via the engine oil circuit, which is why operation of the cam phaser depends on the pressure and the temperature of the engine oil, and therefore on the operating temperature and the rotational speed of the internal combustion engine.

In addition, electric cam phasers are known that operate independently of oil pressure. Due to the electric actuation of the cam phaser, they can also be adjusted in an internal combustion engine that is not operational and additional hydraulic pumps can be avoided in the engine oil circuit. DE 41 10 195 A1 describes an electric cam phaser in which an electric motor effects relative adjustment of the angle of rotation of the camshaft relative to the camshaft gear. Either a threaded portion with a spline or a planetary gear with a self-locking transmission ratio is used as an actuating mechanism. Also the cam phaser described in DE 102 48 355 A1 is actuated by an electric actuator, where the actuator shaft acts upon a double eccentric gear or a double planetary gear. A high gear reduction and low friction of the gear stages allow self-locking of the cam phaser and the use of permanent magnet rotors for the actuator. EP 573 019 B1 in contrast describes a parallel planetary gear mechanism with internal toothing in which several eccentric elements driven by a shaft eccentrically rotate a plurality of gear wheels with external toothing and in sections make them engage with the internal toothing. Strain wave gear mechanisms (harmonic drive gear mechanisms) are known in the art in which an elastic transmission element with external toothing is by an elliptical drive gear in sections pressed into the internal toothing of an outer ring thereby obtaining a high transmission ratio with simultaneously high stiffness of the gear mechanism.

The cam phaser or transmission devices adjustable in the angle of rotation known in prior art entail various problems depending on the design and embodiment. Whereas hydraulic swing motors are in a negative manner dependent upon the pressure and temperature of the engine oil, the respective cam phasers with electric actuation have drawbacks in terms of actuating speed, the required actuating energy, self-locking or of running smoothly, in particular, when being embodied as eccentric gear mechanisms.

Although the designs and concepts for cam phasing known in the art have proven themselves for the use in modern internal combustion engines, there are continuous efforts to realize optimized designs, especially with regard to the large quantities common in the automotive industry, and to eliminate or minimize existing problems. In view of the ongoing innovative activity to increase efficiency of internal combustion engines, there is furthermore generally the necessity to describe new solutions to replace employed designs by optimized or inexpensive concepts.

### SUMMARY OF THE INVENTION

The present invention is therefore based on the object to provide a gear mechanism for improving the problems of gear mechanisms known in prior art associated with relative adjustment of two drive components and to enable high positioning accuracy and operational reliability at the lowest possible construction size and energy consumption.

This object is satisfied for a generic gear mechanism according to the invention in that the transmitter element comprises a revolving transmitter ring which is arranged eccentric relative to the gear axis of rotation and in sections engages with the ring gear and in sections with the sun gear, and in that the actuating device comprises wobble body, where the revolving transmitter ring is by the wobble body movable eccentrically about the gear axis of rotation to move the sun gear and the ring gear relative to each other. Such a gear mechanism, in particular as a cam phaser of an internal combustion engine, provides an effective drive with low power loss of a camshaft or an engine unit. This design according to the invention is not a mere compilation of some partially optimized components, but rather an integral, customized, complex design of a system for power transmission. Whereas current gears in the range of higher transmission ratios are usually realized by multi-stage planetary gear mechanisms in which activation of the gear mechanism for relative adjustment of the drive gears and output gears must be provided with a suitably high-revving actuator, the present invention enables provision of a single or multi-stage gear mechanism which due to the interaction of three rotating gear components and an activation device enables a direct very high gear reduction in a very small space. In most cases, the sun gear is formed as an output gear which is, for example, coupled to a camshaft, whereas the ring gear acts as a drive gear which is, for example, then coupled to the camshaft gear, which is in turn fixedly connected via a timing drive to the crankshaft. In conventional gear mechanisms, the sun gear and the ring gear are formed as toothed elements that engage with a correspondingly internally and externally toothed transmitter ring. Alternatively, the sun gear and the ring gear can also be designed as friction gears or lantern gear elements with which self-locking caused by a high transmission ratio as well as secure transmission of the relative motion of the sun gear and the ring gear is possible.

The central element of the gear mechanism according to the invention is the revolving transmitter ring, in sections being in engagement with the ring gear and the sun and being arranged eccentric to the gear axis of rotation. This circular and bending-resistant ring embedded between the sun gear and the ring gear due to its particular shape enables redirection of forces in a wedge-like effect when in engagement with the sun gear and the ring gear.

Due to the eccentricity of the circular transmitter ring, by means of which the axis of the transmitter ring is offset in an axially parallel manner from the gear axis of rotation, a wobble motion of the transmitter ring about the gear axis of rotation results when actuating the transmitter element, i.e. a rotational motion of the transmitter ring with a change in axis position of the transmitter ring which revolves with the eccentricity e about the gear axis of rotation. The actuating device is provided with a wobble body to drive this relative motion of the transmitter ring wobbling with the eccentricity £ about the gear axis of rotation relative to the sun gear and the ring gear.

While the wobbling transmitter ring performs radial motions, a tangentially acting force moving the sun gear and the ring gear relative to each other arises at the sun gear and ring gear, i.e. the output gear and the drive gear. The geometry of the sun gear, the ring gear and the transmitter ring is coordinated so that the transmitter ring performs the off-center circular wobbling motion with the eccentricity e. With this design according to the invention, high gear reductions can be obtained that achieve very large reduction ratios of over 1,000, at least for two-stage gear mechanisms, which in current prior art represent a technical limitation.

High transmission or reduction ratios by gear mechanisms requiring small installation space are necessary in particular for angle adjustment of two shafts relative to each other and are employed on a large scale in electric cam phasers. In this, the main case of application for such gear mechanisms is the rotational transmission with angular synchronism of the main performance of the timing drive to the camshaft at a certain angle position of the drive gear relative to the camshaft. A relative motion of the axis position of the drive gear to the output gear or to the camshaft, respectively, is effected via the wobbling transmitter element with a power take-off which is supplied via the activation device. Since the power take-off for adjustment of the angle of rotation is preferably to be low and the backlash of the gear mechanism to the actuator should be little, a suitably high gear reduction is provided by the gear mechanism according to the invention, which requires only a small sized actuator. The high gear reduction of the gear mechanism by self-locking of the high transmission ratio prevents a relevant backlash from the drive to the actuator or ensures that the backlash forces acting upon the actuator via the gear can be absorbed by the actuator, respectively.

One advantageous embodiment provides that the eccentric revolving transmitter ring comprise a ring flange and a hollow cylinder attached to the ring flange with an internal toothing and an external toothing, where the internal toothing of the hollow cylinder engages with the sun gear and the external toothing of the hollow cylinder with the ring gear. This design of a transmitter ring wobbling about the gear axis of rotation with eccentricity e allows for a simple design of the gear mechanism according to the invention, in which two different elements fulfill the two functions assigned to the transmitter ring. While the hollow cylinder enables engagement in sections with the ring gear and the sun gear, the ring flange in interaction with the wobble body of the actuating device enables eccentric revolution of the transmitter ring about the gear axis of rotation. For engagement with the internal and the external toothing of the hollow cylinder, the sun gear and the ring gear can be configured with suitable toothing or alternatively as lantern elements, i.e. as a drive disk with bolts protruding axially parallel at least on one side and being concentrically distributed around the circumference. With the arrangement of the hollow cylinder between the sun gear and the ring gear, engagement or transmission, respectively, between the sun gear and the hollow cylinder is despite the wobbling motion of the hollow cylinder implemented substantially in a plane spanned orthogonally to the gear axis, so that a particularly slim gear mechanism can be realized.

For reliable transmission of the eccentric motion of the wobble body to the transmitter ring, the wobble body can be disposed directly within the ring flange. The arrangement of the circular wobble body, offset by eccentricity e from the gear axis of rotation in the ring flange, allows a simple and effective design for transmitting the actuating motion. In addition, a roller or a coupling bearing can in this arrangement be positioned in a simple manner between the wobble body and the ring flange in order to minimize friction losses.

The hollow cylinder can for the gear mechanism according to the invention preferably be formed by a corrugated band. The combination of a corrugated band, being easily produced by metal forming, with a ring flange allows for very delicate toothing of the gear mechanism, while obtaining a very thin wall thickness for the hollow cylinder, with which a high reduction can be realized already when using a single-stage gear mechanism that enables effective use in a cam phaser. A corrugated band, in addition to the inexpensive production of the transmitter element, provides the option of controlling the tribological conditions of the contact situation of the interior and exterior toothing of the hollow cylinder to the sun gear and ring gear such that backlash-free operation is possible at much higher dynamics. In addition to a two-part production and subsequent fixation of the corrugated band on the ring flange, known thermoforming processes enable a single-piece production of the transmitter ring with axial torsion-resistant fixation of the corrugated band at the thermoformed ring flange. The corrugated band formed in a circular shape at the same time forms a positive-fit toothing geometry with the ring gear and with the sun gear Fixation on the ring flange allows torsion-resistant structural stability of the corrugated band in the radial and axial direction, while on the other hand, the corrugated band continues to provide elasticity along the circular circumference which enables distribution of the contact geometry onto several contact points on the sun gear and the ring gear that mutually relieve each other of load.

An advantageous embodiment provides that the wobble body is mounted coaxial to the gear axis of rotation and has a circular actuating disk, where the actuating disk is disposed eccentric relative to the gear axis of rotation. In accordance with the eccentric arrangement of the revolving transmitter ring relative to the gear axis of rotation, the actuation disk interacting with the transmitter ring is also offset from the gear axis by eccentricity e, such that the center axis of the circular actuating disk wobbles about the gear axis of rotation in an axially parallel manner. With the main case of application, being the rotational transmission with angular synchronism of a rotational motion from the ring gear to the sun gear, i.e. without any relative motion of the sun gear and the ring gear to each other, the relative position of the wobble body or the eccentrically disposed actuating disk, respectively, also does not change relative to the revolving transmitter ring, so that the wobble body and the transmitter ring rotate together about the gear axis of rotation There is also a motion between the circular actuating disk and the transmitter ring only when actuating the wobble body for relative adjustment of the rotational angle position between the sun gear and the ring gear, where the assembly of a needle or ball bearing between the transmitter ring and the circular actuating disk reduces friction losses. The wobble body can advantageously comprise a shaft stub which is fixedly connected to the actuating disk and is mounted coaxial to the gear axis of rotation. Mounting the actuating device relative to the sun gear, in particular in the main case of application of a rotational transmission, avoids significant friction loss, where a relative motion of the components of the gear mechanism relative to each other is during use as a cam phaser avoided by coupling the sun gear to the camshaft.

A further embodiment provides that the sun gear comprises an external toothing and the ring gear an internal toothing, where the number of teeth of the external toothing of the sun gear is smaller than the number of teeth of the internal toothing of the hollow cylinder and the number of teeth of the external toothing of the hollow cylinder is smaller than the number of teeth of the internal toothing of the ring gear. To reduce power loss, the toothing geometry of the contact partners can, despite inexpensive production and the use of standard components, be optimized by special design. With regard to a large number of teeth of the sun gear, the ring gear, and the transmitter ring necessary for a high transmission ratio, engagement of the toothing does not necessarily need to have the same spacing, but in a simple embodiment needs only a similar spacing which causes no technical impairment considering the only few points of contact. Given the respective delicacy of the toothing of the sun gear, the ring gear, and the hollow cylinder, for example, comprising micro-toothing, with which the number of teeth of the intermeshing toothings exceeds 100, a high reduction ratio can be achieved already with a single-stage gear mechanism, where the numerical difference between the external toothing of the sun gear and the internal toothing of the hollow cylinder as well as between the external toothing of the hollow cylinder and the internal toothing of the ring gear amounts to preferably two teeth, in particular one tooth.

A preferable variant provides that the actuating device is coupled to an actuating drive, preferably to an electric motor. Such a simple drive of the actuating device, which with respect to the arrangement and mounting of the actuating device, performs a coaxial motion relative to the sun gear and the ring gear and via the eccentrically arranged actuating disk or a respective eccentrically revolving actuating device causing the wobble motion of the circular transmitter ring, enables easy implementation of a power take-off in the gear mechanism. In this, the use of an electric motor, unlike conventional hydraulic drives or mechanical drives, can represent an inexpensive solution for actuating the actuating device, where the electric motor can in addition to a commonly small design size also be easily adapted to various conditions.

It is of further advantage when the sun gear or a coaxially coupled component comprises a bearing seat on which the ring gear is mounted. Mounting the ring gear on the sun gear facilitates relative adjustment of the angle of rotation of the ring gear to the sun gear. Accordingly, it is easier for a cam phaser, which effects adjustment of the angle of rotation to the camshaft gear coupled to the ring gear, to adjust the angular position of the camshaft that is coupled to the sun gear.

A particular embodiment provides that the gear mechanism is formed two-stage, where the two-stage gear mechanism comprises a first and a second externally-toothed sun gear, a first and a second internally-toothed ring gear, a first and second eccentrically revolving transmitter element and a first and second wobble body. A two-stage gear mechanism allows a very high reduction ratio and good self-locking of the gear mechanism associated therewith. Depending on which elements of the first and second stages of the gear mechanism are stationary or are coupled together, respectively, the combination of several stages allows a change of the sign of the transmission, so that an angle subtraction of the transmissions slightly deviating from one another occurs, whereby extremely large transmission ratios can be realized.

For forming a multiplicative gear in a two-stage gear mechanism, an actuating drive can be provided that is coupled to the first wobble body, where the first and the second ring gear as well as the first sun gear and the second wobble body are fixedly coupled to each other, and where a drive is coupled to the first or the second ring gear and an output is coupled to the second sun gear.

This multiplicative interconnection of the first and the second gear stages, via the multiplication of the transmission ratios of the first and the second gear stage, leads to high transmission ratios which with the application of such a two-stage gear as a cam phaser for an internal combustion engine, in which the drive is connected to the camshaft gear and the output to the camshaft, [sic] effective adjustment of the angle of rotation and secure self-locking of the gear mechanism.

In an alternative multiplicative gear embodiment of a two-stage gear mechanism, the first and the second sun gear as well as the first ring gear and the second wobble body can be fixedly coupled to each other, where the actuating drive is then coupled to the first wobble body, the main drive to the first ring gear, and the output to the second sun gear. This alternative multiplicative embodiment leads to a high reduction ratio and good self-locking.

For the design of a subtractive gear of a two-stage gear mechanism, an actuating drive can be provided which is coupled to the first or the second wobble body, where the first and the second wobble body as well as the first and the second sun gear are fixedly coupled to each other, and where a drive is coupled to the first ring gear and an output to the second ring gear. Such subtractive coupling of the first and the second gear stage enables a very effective gear combination with an extremely high transmission ratio in which angle subtraction of the angles of two transmission ratios slightly diverging from each other occurs. In addition to this subtractive coupling of the components of the first and the second gear stages of a two-stage gear, further subtractive gear interconnections are possible, for example, a complementary arrangement where the drive is coupled to the first sun gear and the output to the second sun gear. When used as cam phasers for an internal combustion engine, subtractive gears enable extremely high reduction ratios and thereby also precise angle adjustment of the camshaft relative to the camshaft gear.

The present invention also relates to a cam phaser for an internal combustion engine with a gear mechanism according to the invention, where the transmitter element comprises a revolving transmitter ring which is arranged eccentric to the gear axis of rotation and in sections engages with the ring gear and in sections with the sun gear, and in which the actuating device comprises a wobble body, where the revolving circular transmitter ring is by the wobble body movable eccentrically about the gear axis of rotation to move the sun gear and the ring gear relative to each other. The ring gear is there coupled to a crankshaft-fixed camshaft gear of the internal combustion engine and the sun gear is coupled to a camshaft of the internal combustion engine. Such a cam phaser with a large reduction ratio and good self-locking, despite the use of simple components, enables secure adjustment of the angle of rotation of the camshaft relative to the camshaft gear of an internal combustion engine.

### BRIEF DESCRIPTION OF THE DRAWINGS

Hereinafter, an embodiment of the gear mechanism according to the invention is explained in detail with reference to drawings. In the drawings:

FIG. 1 shows a cross-sectional view of a gear mechanism according to the invention, in particular for a cam phaser of an internal combustion engine;

FIG. 2a shows a perspective side view of the gear mechanism of FIG. 1 from the direction of the output shaft;

FIG. 2b shows a partially cut-away perspective side view of gear mechanism of FIG. 2a;

FIG. 3 shows a partially cut-away side view of the gear mechanism of FIG. 1 from the direction of the output shaft;

FIG. 4a shows a perspective side view of the gear mechanism of FIG. 1 from the direction of the power take-off shaft;

FIG. 4b shows a partially cut-away side view of the gear mechanism of FIG. 4a;

FIG. 5 shows a side view of the gear mechanism of FIG. 1 from the direction of the power take-off shaft; and

FIG. 6 shows a schematic side view of a cam phaser according to the invention with the gear mechanism of FIG. 1.

### DETAILED DESCRIPTION

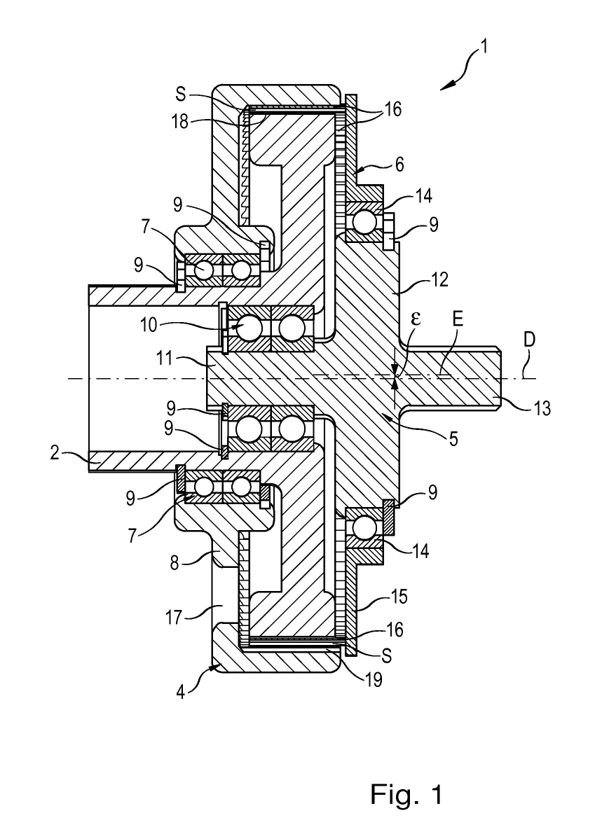

The sectional view in FIG. 1 shows an embodiment of a gear mechanism 1 according to the invention which can be used as a cam phaser in an internal combustion engine. In the sectional view of this gear mechanism 1 designed being single-stage, a sun gear 3 connected to an output shaft 2 can be seen as well as a ring gear 4 surrounding the sun gear 3. An actuating device 5 is provided on the side of the gear mechanism 1 opposite to the output shaft 2 and acts upon a transmitter element 6.

The output shaft 2 being formed as a hollow shaft, which when using the gear mechanism for cam phasing is coupled to the camshaft (not shown) of the internal combustion engine, is in this embodiment formed integrally with the sun gear 3, which extends very far from the output shaft 2 in the direction of the ring gear 4, so that only a relatively small spacing remains between the sun gear 3 and the ring gear 4 which is always of the same size along the circumference. A double ball bearing 7 is on the outer circumference of the output shaft 2 provided on which the ring gear 4 is rotatably mounted relative to the sun gear 3. For fixedly arranging the double ball bearing 7 on the outer circumference of the output shaft 2 and in a bearing seat of a ring gear flange 8 of the ring gear 4, two retaining rings 9 are provided which fix the double ball bearing 7 relative to respective abutment shoulders on the output shaft 2 and the bearing seat of the ring gear flange 8. A further double ball bearing 10 is provided on the inner circumference of the output shaft 2 being formed as a hollow shaft with which the shaft stud 11 of the actuating device 5 is supported relative to the output shaft 2 or the sun gear 3, respectively, coaxial to the axis of rotation D. This double ball bearing 10 disposed within the output shaft 2 is likewise fixed by two retaining rings 9 relative to a step on the inner circumference of the output shaft 2 and a step on the shaft stud 11. The gear axis of rotation D is concentric to the output shaft 2 and the sun gear 3 as well as to the ring gear 4.

The actuating device 5, being mounted in the output shaft 2 on the shaft stub 11 coaxial to the gear axis of rotation D, comprises a wobble body 12 and an power take-off shaft 13 on which an actuator (not shown), commonly an electric motor, is arranged in order move the wobble body 12 eccentrically relative to the to gear axis of rotation D. While the shaft stub 11 and the power take-off shaft 13 disposed oppositely from the wobble body 12 are formed coaxial to the gear axis of rotation D, so that both the rotation of the actuating device in double ball bearing 10 as well as the drive motion of the actuating device 5 is via the power take-off shaft 13 is performed concentrically to the gear axis of rotation D, the wobble body 12 is arranged eccentric to the gear axis of rotation D. The wobble body 12 being formed in a circular manner is there positioned offset from the gear axis of rotation D by the eccentricity £, so that axis E of the circular wobble body 12 with a rotational motion forced by the power take-off shaft 13 wobbles about the gear axis of rotation D with the eccentricity £. With each rotational motion of the actuating device 5, the position of axis E therefore changes relative to the gear axis of rotation D. The ball bearing 14 arranged at the outer circumference of the wobble body 12 and fixed by a further retainer ring 9 as well as the ring flange 15 of the transmitter element 6 arranged from the outside on the ball bearing 14 also wobble together with the circular wobble body 12. The ring flange 15 of the transmitter element 6 is a circular bending-resistant disk that is disposed on the outer ring of the ball bearing 14 and wobbles with the motion of the wobble body 12 with the eccentricity e about the gear axis of rotation D. A corrugated band 16 is as a toothed hollow cylinder disposed on the ring flange 15 equidistant to axis E, so that the corrugated band 16 also activates [sic] by the wobble body 12 wobbles with eccentricity e about the gear axis of rotation D.

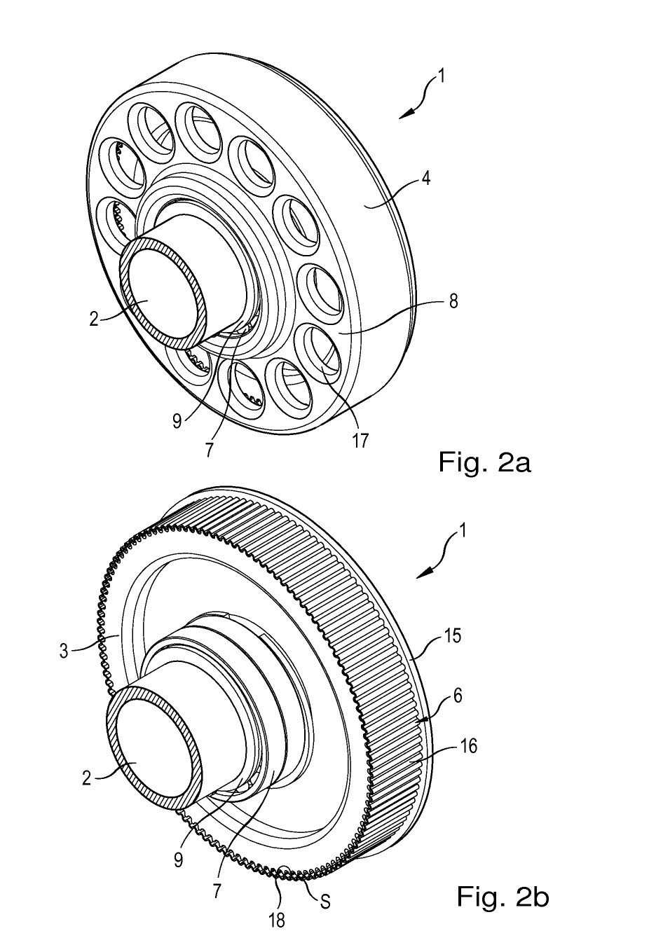

The perspective view of the gear mechanism 1 in FIG. 2a in addition to the protruding drive shaft 2 also shows the ring gear 4 supported on the double ball bearing 7 at the outer circumference of the drive shaft 2. The ring gear flange 8 extending radially outwardly from the double ball bearing 7 is there provided with a series of bores 17 in order to reduce the weight of the ring gear.

The perspective view of the gear mechanism 1 in FIG. 2, represented without the ring gear 4, clearly shows the corrugated band 16 disposed on the ring flange 15 of the transmitter element 6. The sun gear 3 with the external toothing 18 is positioned within the corrugated band 16, where the external toothing 18 in the upper section of FIG. 2b engages with the corrugated band 16 arranged eccentric to the gear axis of rotation D, while there is a gap S at the lower side between the external toothing 18 and the corrugated band 16.

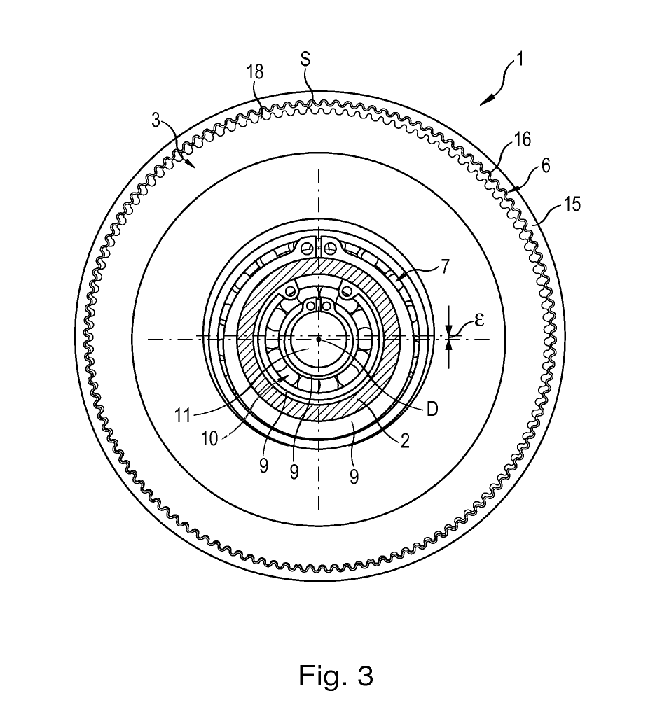

Engagement only in sections between the corrugated band 16 and the external toothing 18 of the sun gear 3 is seen more clearly in the side view in FIG. 3. Also this view of the gear mechanism 1, seen from the perspective of the output shaft 2, is again shown without the ring gear 4. The corrugated band 16 disposed on the ring flange 15 is there as well again positioned offset by eccentricity e to the gear axis of rotation D, so that the corrugated band 16 is there in the lower section of FIG. 3 in engagement with the external toothing 18 of the sun gear 3, whereas the gap S arises on the opposite side between the corrugated band 16 and the external toothing 18, where the spacing of the toothings presently amounts to approximately twice the eccentricity e.

Engagement in sections between the corrugated band 16 and the internal toothing 19 of the ring gear 4, which is not shown in FIGS. 2b and 3, occurs at the side of the corrugated band 16 facing away from the engagement of the corrugated band 16 and the external toothing 18 of the sun gear 3, i.e. at the section of the corrugated band 16 located at the bottom in FIG. 2b or respectively at the section of the corrugated band 1b located at the top in FIG. 3.

Due to the eccentricity e to the gear axis of rotation D on the other hand, a further gap exists in the lower section of FIG. 3 between the internal toothing 19 of the ring gear 4 (presently not shown) and the corrugated band 16 and enables transmission between the internal toothing 19 and the corrugated band 16.

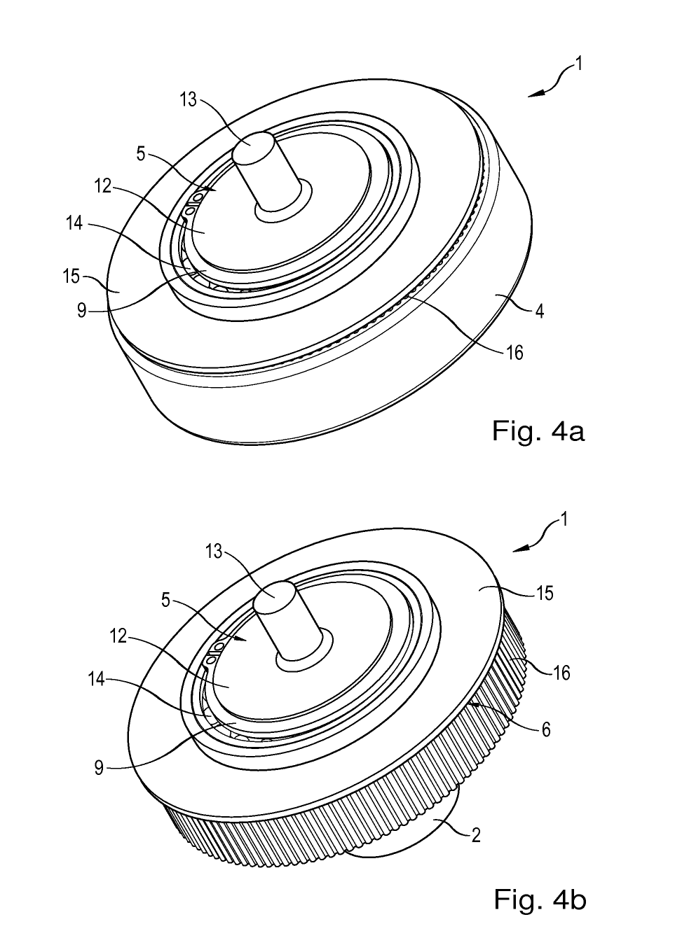

The perspective view in FIG. 4a shows the gear mechanism 1 according to the invention in a view from the side of the actuating device 5. At the actuating device 5, the power take-off shaft 13 protrudes out from the wobble body 12. The circular wobble body 12 revolving eccentrically relative to gear axis of rotation D acts via the ball bearing 14 upon the ring flange 15, so that the corrugated band 16 connected to the ring flange 15 in sections engages with the internal toothing of the ring gear 4. The corrugated band 16 disposed on the circular ring flange 15 is clearly visible in the representation of this perspective view without the ring gear 4 in FIG. 4b which revolves eccentrically in a wobbling manner relative to the gear axis of rotation D activated by the wobble body 12 of the actuating device 5 despite the concentric arrangement to axis E.

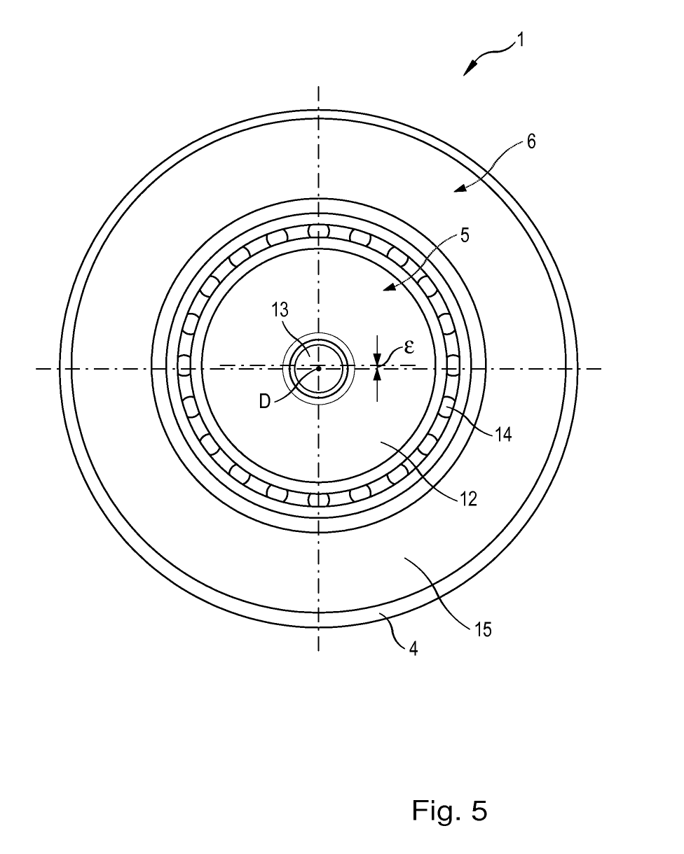

The side view of the gear mechanism 1 shown in FIG. 5 from the direction of the actuating device 6 clearly shows the eccentricity e of the wobble body 12 fixedly connected to the power take-off shaft 13, whereas the power take-off shaft 13 is disposed coaxial to the gear axis of rotation D. Activated by the eccentrically disposed wobble body 12, also the ball bearing 14 and the ring flange 15 of the actuating device 5 are arranged eccentric to the gear axis of rotation D and respectively offset from the ring gear 4.

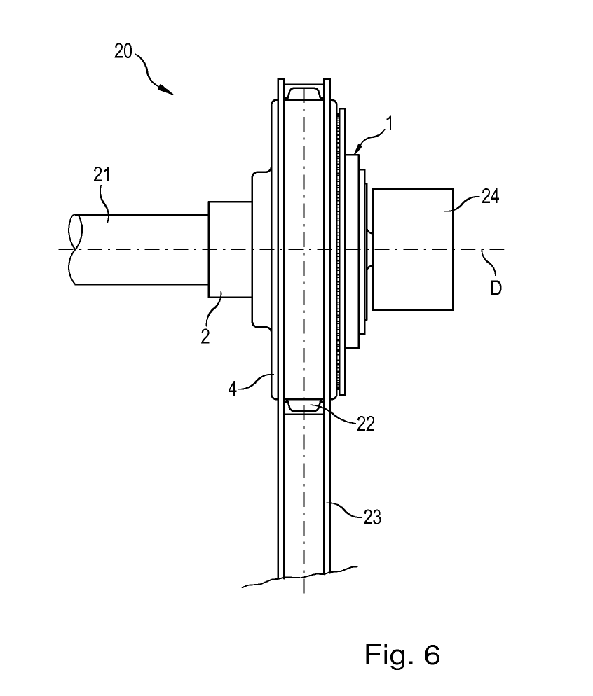

FIG. 6 shows a perspective side view of a cam phaser 20 according to the invention on the basis of a gear mechanism 1 adjustable in the angle of rotation. The gear mechanism 1 is with the drive shaft 2 formed as a hollow shaft seated fixedly on the camshaft 21 of the internal combustion engine, so that the sun gear 3 together with the camshaft 21 revolve about the gear axis of rotation D. On the outer circumference of the ring gear, a camshaft gear wheel 22 is disposed which is via a timing chain 23 connected to the crankshaft (not shown) of the internal combustion engine in a manner fixing the angle of rotation. An electric motor 24 is provided at the power take-off shaft 13 of the actuating device 5 for adjusting the rotational angle position between the ring gear 4 and the sun gear 3 of the gear mechanism 1 respectively between the crankshaft-fixed camshaft gear wheel 22 and the camshaft 21.

This motor 24 can there co-rotate with the rotational motion of the main drive, so that the relative rotational motion of the main drive is merely accelerated or decelerated by the electric motor 24 to achieve a desired adjustment of the angle of rotation.

The function and the mode of operation of a gear mechanism 1 according to the invention is herebelow explained in detail.

During operation of the gear mechanism 1 according to the invention, in particular as a cam phaser 20 in an internal combustion engine, the rotational motion of the main drive of the camshaft gear wheel 22 mounted on the ring gear 4 is for the transmission of a main drive, for example, the transmission of the motion of the crankshaft (not shown) of the internal combustion engine via the gear mechanism 1 to the connected cam shaft 21, transmitted via the internal toothing 19 of the ring gear 4 to the corrugated band 16 of the transmitter element 6, and from there to the external toothing 18 of the sun gear 3, which is via the connection to the output shaft 2 coupled to the camshaft 21 of the internal combustion engine.

As clearly shown in FIG. 1, simultaneous engagement in sections of the ring gear 4 and the sun gear 3 with the transmitter element 6, where engagement of the internal toothing 19 of the ring gear 4 with the corrugated band 16 of the transmitter element 6 occurs on one side of the transmitter element 6 (in FIG. 1 at the top) and engagement of the external toothing 18 of the sun gear 3 with the corrugated band 16 of the transmitter element 6 occurs on a radially oppositely disposed side of the transmitter element 6 (in FIG. 1 at the bottom), enables direct transfer of the rotational motion of the main drive from the ring gear 4 to the sun gear 3, thereby preventing negative backlash via the transmitter element 6 and the actuating device 5 to the electric motor 24 attached to the power take-off shaft 13 of the actuating device 5.

For adjustment of the angle of rotation between the ring gear 4 and the sun gear 3, when using a cam phaser respectively between a camshaft gear wheel 22 attached to the ring gear 4 and a camshaft 21 attached via the output shaft 2 to the sun gear 3, an additional rotational motion is in addition to the permanent crankshaft rotation transmitted to the wobble body 12 via the power take-off shaft 13. For this purpose, a suitable drive is attached to the power take-off shaft 13, commonly a traveling electric motor 24. The transmitter element 6, mounted eccentric to the gear axis of rotation D, is via the eccentric rotational motion of the wobble body 12 also activated to perform a wobbling motion about the gear axis of rotation D. A ball bearing 14 is positioned between the wobble body 12 of the actuating device 5 and the ring flange 15 of the transmitter element 6 to enable a relative motion between the wobble body 12 and the ring flange 15 with the lowest possible friction. Roller bearings or sliding bearings can alternatively also be used between the wobble body 12 and the ring flange 15. The eccentrically projecting portion of the ring-shaped wobble body 12 presses the corrugated band 16 of the transmitter element 6 via the ball bearing 14 and the ring flange 15 into engagement with the internal toothing 19 of the ring gear 4, so that the corrugated band 16 during one revolution of the swash plate body 12 rolls once around the internal toothing 19 of the ring gear 4 over the entire circumference of the ring gear 4. In this, the ring gear 4 and the corrugated band 16 move relative to each other by the difference between the number of teeth of the internal toothing 19 of the ring gear 4 and the number of teeth or corrugations of the corrugated band 16. Accordingly, the reduction ratio results from the difference in the number of teeth between the sun teeth and the internal teeth of the internal toothing 19 of the ring gear 4.

While on the one side, the wobble body 12, being offset by the eccentricity e relative to the gear axis of rotation D, presses the corrugated band 16 of the transmitter element 6 into engagement with the internal toothing 19 of the ring gear 4, a gap S arises on the oppositely disposed side of the gear mechanism 1 between the internal toothing 19 of the ring gear 4 and the corrugated band 16 of approximately twice the eccentricity e, so that an overcut of protruding teeth of the internal toothing 19 and the corrugated band 16 is possible without any problem. For this, the height of the teeth of the internal toothing 19 and height of the corrugations of the corrugated band 16 must be slightly less that the eccentricity e of the wobble body 12. While a gap S is formed on this side facing away between the corrugated band 16 and the internal toothing 19 of the ring gear 4, the corrugated band 16 there at the same time in engages sections with the external toothing 18 of the sun gear 3. This engagement in sections between the external toothing 18 of the sun gear 3 and the corrugated band 16 when revolving the swash plate body 12 travels around the circumference of the sun gear 3, so that the sun gear 3 during one revolution of the swash plate body 12 moves relative to the corrugated band 16 by the difference in the number of teeth between the external toothing 18 of the sun gear 3 and the teeth or corrugations, respectively, of the corrugated band 16. Here as well, the transmission ratio again results from the difference between the number of teeth of the external toothing 18 and the corrugated band 16 to the number of teeth of the external toothing 18 of the sun gear 3.

When adjusting the angle of rotation between the sun gear 3 and the ring gear 4 of the gear mechanism 1, respectively an adjustment of the angle of rotation between a camshaft 21 arranged on the output shaft 2 and a camshaft gear wheel 22 attached to the ring gear 4, the co-rotating rotor of the electric motor 24, in the event of using an electric motor, being arranged on the power take-off shaft 13 is accelerated or decelerated, so that the position of the swash body 12 and therefore also of the transmitter element 6 changes relative to the sun gear 3 and the ring gear 4. With the mere transmission of the main drive to the output shaft 2, i.e. the mere transmission of the rotational motion of the crankshaft-fixed camshaft gear wheel 22 to the camshaft 21, the sun gear 3 and the ring gear 4 do not change their relative position to each other. With the motion of the corrugated band 19 of the transmitter element 6, or a respective internally and externally toothed hollow cylinder, the corrugated band 16 revolves in sections on the internal toothing 19 of ring gear 4 as well as offset by 180° in sections on the external toothing 18 of the sun gear 3, whereby the sun gear 3 and the ring gear 4 move relative to each other. Since the number of teeth of the internal toothing 19 is greater than the number of teeth or corrugations, respectively, of the corrugated band 16, the ring gear 4 moves relative to the rotational motion forced by the main drive against the direction of rotation of the wobble body 12, which due to the eccentric motion causes the corrugated band 12 to roll on the internal toothing 19. In contrast thereto, the sun gear 3 is due to the lower number of teeth of the outer toothing 18 relative to the number of teeth or corrugations, respectively, of the corrugated band 16 moved relative to the rotational motion forced by the main drive in the direction of rotation of the wobble body 12, so that the relative motions of the sun gear 3 and the ring gear 4 activated by the wobble body 12 oppose and therefore partially cancel each other.

The gear mechanism 1 according to the invention shown in the embodiment in FIGS. 1 through 5 on the external toothing 18 of the sun gear 3 and the internal toothing 19 of the ring gear 4 comprises micro-toothing co-acting with the corrugated band 16 of the transmitter element 6 and comprising a corresponding corrugated contour. The number of corrugations of the corrugated band there amounts to approximately 120, whereas the number of teeth of the external toothing 18 and the internal toothing 19 is lower or respectively larger by one For the partial gear ratio between the corrugated band 16 and the ring gear 4 for a number of teeth of the ring gear 4 of 121, a transmission ratio of 1:121 results. The external toothing 18 of the sun gear 3 in contrast comprises one tooth less than the number of corrugations of the corrugated band, so that a transmission ratio of 1:119 results for the partial gear ratio between the corrugated band 16 and sun gear 3. Since the directions of these reduction ratios between the ring gear and the corrugated band and between the sun gear and the corrugated band are different and therefore partially cancel each other, the partial transmission ratios of the gear mechanism 1 must be deducted from each other. Since the partial reduction ratios of the gear mechanism 1 only differ slightly in magnitude, a total reduction ratio of far more than 1:1000 results despite the already high reduction ratios of approximately 1:120. Even with conventional toothings having tooth numbers of about 50 and differences in the number of teeth of 2 to 3, reduction ratios of over 100 are obtained for the gear mechanism 1 according to the invention. Accordingly, transmission devices with a very high reduction ratio can be realized with the gear mechanism 1 according to the invention, even though the gear is only formed as a single stage and engagement between the sun gear 3 and the corrugated band 16 as well as between the corrugated band 16 and the ring gear 4 additionally occurs in the same plane spanned orthogonal to the gear axis of rotation D.

### LIST OF REFERENCE NUMERALS

1: gear mechanism
2: output shaft
3: sun gear
4: ring gear
5: actuating device
6: transmitter element
7: double ball bearing
8: ring gear flange
9: retainer ring
10: double ball bearing
11: shaft stub
12: wobble body
13: power take-off shaft
14: ball bearing
15: ring flange
16: corrugated band
17: bores
18: external toothing
19: internal toothing
20: cam phaser
21: camshaft
22: camshaft gear wheel
23: timing chain
24: electric motor
D: gear axis of rotation
E: axis
S: gap
ε: eccentricity

1. A gear mechanism with a sun gear and a ring gear, where said sun gear and said ring gear are arranged coaxial relative to a gear axis of rotation, and with a transmitter element and an actuating device, where said transmitter element comprises a revolving transmitter ring which is arranged eccentric to said gear axis of rotation and in sections engages with said sun gear and in sections with said ring gear, and that said actuating device comprises a wobble body, where said revolving transmitter ring is by said wobble body movable eccentrically about said gear axis of rotation to move said sun gear and said ring gear relative to each other,
wherein said eccentrically revolving transmitter ring comprises a ring flange and a corrugated band comprising an internal toothing and an external toothing and being attached to said ring flange, where said internal toothing of said corrugated band engages with said sun gear and said external toothing of said corrugated band with said ring gear.

2. The gear mechanism according to claim 1,
wherein said eccentrically revolving transmitter ring comprises a ring flange and a hollow cylinder being attached to said ring flange and comprising an internal toothing and an external toothing, where said internal toothing of said hollow cylinder engages with said sun gear and said external toothing of said hollow cylinder with said ring gear.

3. The gear mechanism according to claim 2,
wherein said wobble body is arranged in said ring flange.

4. The gear mechanism according to claim 2,
wherein said hollow cylinder is formed from a corrugated band.

5. The gear mechanism according to claim 1,
wherein said wobble body is mounted coaxial relative to said gear axis of rotation and is formed as a circular actuating disk, where said actuating disk is arranged eccentric relative to said gear axis of rotation.

6. The gear mechanism according to claim 1,
wherein said actuating device comprises a shaft stub being fixedly connected to said wobble body, where said shaft stub is mounted coaxial relative to said gear axis of rotation.

7. The gear mechanism according to claim 1,
wherein said sun gear comprises an external toothing and said ring gear an internal toothing, where the number of teeth of said external toothing of said sun gear is smaller than the number of teeth of said internal toothing of said hollow cylinder and the number of teeth of said outer toothing of said hollow cylinder is smaller than the number of teeth of said internal toothing of said ring gear.

8. The gear mechanism according to claim 1,
wherein said actuating device is coupled to an actuating drive, preferably an electric motor.

9. The gear mechanism according to claim 1,
wherein said sun gear comprises a bearing seat on which said ring gear is supported.

10. The gear mechanism according to claim 1,
wherein said gear mechanism is formed two-stage, where said two-stage gear mechanism comprises a first and a second externally-toothed sun gear, a first and a second internally-toothed ring gear, a first and a second eccentrically revolving transmitter element and a first and a second wobble body.

11. The gear mechanism according to claim 10,
wherein an actuating drive is provided being coupled to said first wobble body, where said first and said second ring gear as well as said first sun gear and said second wobble body are fixedly coupled to each other and where a drive is coupled to said first or said second ring gear and an output to said second sun gear.

12. The gear mechanism according to claim 10,
wherein an actuating drive is provided which is connected to said first or said second wobble body, where said first and said second wobble body as well as said first and said second sun gear are fixedly coupled to each other, and where a drive is coupled to said first ring gear and an output to said second ring gear.

13. A cam phaser for an internal combustion engine with a gear mechanism according to claim 1, where said ring gear is coupled to a crankshaft-fixed camshaft gear of said internal combustion engine and said sun gear to a camshaft of said internal combustion engine.
